(19) United States
(12) Patent Application Publication
(10) Pub. No.: US 2018/0352158 A1
(43) Pub. Date: Dec. 6, 2018

(54) OMNIDIRECTIONAL CAMERA CAPTURED IMAGE DISPLAY SYSTEM, OMNIDIRECTIONAL CAMERA CAPTURED IMAGE DISPLAY METHOD, AND PROGRAM

(71) Applicant: OPTiM Corporation, Saga-shi (JP)

(72) Inventor: Shunji SUGAYA, Tokyo (JP)

(21) Appl. No.: 16/057,981

(22) Filed: Aug. 8, 2018

Related U.S. Application Data
(63) Continuation-in-part of application No. PCT/JP2016/064661, filed on May 17, 2016.

(51) Int. Cl. H04N 5/232; G06T 7/73; H04N 5/247; G06T 7/55

(52) U.S. Cl. CPC H04N 5/23238; G06T 7/74; H04N 5/247; G06T 17/00; G06T 7/55; H04N 5/232939; H04N 5/23299

(57) ABSTRACT

It is provided an omnidirectional camera captured image display system, an omnidirectional camera captured image display method, and a program for capable of facilitating knowing a distance from an omnidirectional camera to a subject or creating a 3D model corresponding to the subject displayed in an omnidirectional image, by displaying the distance from a position of the omnidirectional camera to the subject. An omnidirectional camera captured image display system 1 for displaying a captured image obtained by capturing a subject by a plurality of omnidirectional cameras 100 displays, in the subject displayed as the captured image, a distance from the omnidirectional cameras 100 to the subject.

### CROSS-REFERENCE TO RELATED APPLICATION

This application is a continuation-in-part of PCT Application No. PCT/JP2016/064661 filed on May 17, 2016, the entire contents of which are incorporated herein by reference.

### BACKGROUND

### (a) Field

The present invention relates to an omnidirectional camera captured image display system, an omnidirectional camera captured image display method, and a program for displaying captured images captured by a plurality of omnidirectional cameras.

### (b) Description of the Related Art

In recent years, an omnidirectional camera capable of capturing 360-degree panoramic images in all directions of up, down, left, and right has been proposed. In such an omnidirectional camera, in order to image the entire visual field, it is possible to capture an omnidirectional image by an image capturing device which uses a plurality of cameras as one device or an image capturing device having a plurality of special lenses and to display a 360-degree panoramic image as a display image.

As such a configuration, a configuration is disclosed in which a plurality of image captures devices are provided, and a plurality of images acquired from the respective image capturing devices are combined as one image to generate the omnidirectional image (see Japanese Patent Application Publication No. 2016-27744 (hereinafter referred to as “'744 publication”).

However, in the configuration of '744 publication, since a depth of a subject displayed as the omnidirectional image is unknown, it is difficult to know a distance from the omnidirectional camera to the subject or to create a 3D model corresponding to the subject displayed in the omnidirectional image. As such, there is a technical problem in the existing technology related to the captured image display that the convenience of the captured image display is low because it is difficult to know a distance from the omnidirectional camera to the subject or to create the 3D model corresponding to the subject displayed in the omnidirectional image.

### SUMMARY

An aspect of the present invention provides an omnidirectional camera captured image display system, an omnidirectional camera captured image display method, and a program for capable of facilitating knowing a distance from an omnidirectional camera to a subject or creating a 3D model corresponding to the subject displayed in an omnidirectional image, by displaying a distance from a position of the omnidirectional camera to the subject.

A first aspect of the present invention provides an omnidirectional camera captured image display system for displaying a captured image obtained by capturing a subject by a plurality of omnidirectional cameras, the omnidirectional camera captured image display system including a distance display unit that displays, in the subject displayed as the captured image, a distance from the omnidirectional cameras to the subject.

According to the first aspect of the present invention, an omnidirectional camera captured image display system for displaying a captured image obtained by capturing a subject by a plurality of omnidirectional cameras displays, in the subject displayed as the captured image, a distance from the omnidirectional cameras to the subject.

The invention according to the first aspect is a category of an omnidirectional camera captured image display system, but exhibits the same action and effect corresponding to the category even in other categories such as a method, a program, and the like.

A second aspect of the present invention provides an omnidirectional camera captured image display system for displaying a 3D model of a subject, which is created from a captured image obtained by capturing the subject by a plurality of omnidirectional cameras, the omnidirectional camera captured image display system including a distance display unit that displays, in the subject displayed as the 3D model, a distance from the omnidirectional cameras to the subject.

According to the second aspect of the present invention, an omnidirectional camera captured image display system for displaying a 3D model of a subject, which is created from a captured image obtained by capturing the subject by a plurality of omnidirectional cameras, displays, in the subject displayed as the 3D model, a distance from the omnidirectional cameras to the subject.

The invention according to the second aspect is a category of an omnidirectional camera captured image display system, but exhibits the same action and effect corresponding to the category even in other categories such as a method, a program, and the like.

A third aspect of the present invention provides the omnidirectional camera captured image display system, which is the invention according to the first or second aspect, including an accepting unit that accepts a user operation, and a switching unit that switches ON/OFF of display of the distance by receiving the user operation.

According to the third aspect of the present invention, the omnidirectional camera captured image display system, which is the invention according to the first or second aspect, accepts a user operation and switches ON/OFF of display of the distance by receiving the user operation.

A fourth aspect of the present invention provides the omnidirectional camera captured image display system, which is the invention according to the first or second aspect, including a distance correcting unit that corrects the distance from distortion of the captured image.

According to the fourth aspect of the present invention, the omnidirectional camera captured image display system, which is the invention according to the first or second aspect, corrects the distance from distortion of the captured image.

A fifth aspect of the present invention provides the omnidirectional camera captured image display system, which is the invention according to the first or second aspect, including an orientation correcting unit that makes orientations of the plurality of omnidirectional cameras in parallel.

According to the fifth aspect of the present invention, the omnidirectional camera captured image display system, which is the invention according to the first or second aspect, makes orientations of the plurality of omnidirectional cameras in parallel.

A sixth aspect of the present invention provides the omnidirectional camera captured image display system, which is the invention according to the first or second aspect, including a measuring unit that measures a distance between the plurality of omnidirectional cameras.

According to the sixth aspect of the present invention, the omnidirectional camera captured image display system, which is the invention according to the first or second aspect, measures a distance between the plurality of omnidirectional cameras.

A seventh aspect of the present invention provides an omnidirectional camera captured image display method for displaying a captured image obtained by capturing a subject by a plurality of omnidirectional cameras, the omnidirectional camera captured image display method including displaying, in the subject displayed as the captured image, a distance from the omnidirectional cameras to the subject.

An eighth aspect of the present invention provides an omnidirectional camera captured image display method for displaying a 3D model of a subject, which is created from a captured image obtained by capturing the subject by a plurality of omnidirectional cameras, the omnidirectional camera captured image display method including displaying, in the subject displayed as the 3D model, a distance from the omnidirectional cameras to the subject.

A ninth aspect of the present invention provides a program for causing an omnidirectional camera captured image display system for displaying a captured image obtained by capturing a subject by a plurality of omnidirectional cameras to execute displaying, in the subject displayed as the captured image, a distance from the omnidirectional cameras to the subject.

A tenth aspect of the present invention provides a program for causing an omnidirectional camera captured image display system for displaying a 3D model of a subject, which is created from a captured image obtained by capturing the subject by a plurality of omnidirectional cameras, to execute displaying, in the subject displayed as the 3D model, a distance from the omnidirectional cameras to the subject.

An eleventh aspect of the present invention provides an omnidirectional camera captured image display system for displaying a captured image obtained by capturing a subject by a plurality of omnidirectional cameras, the omnidirectional camera captured image display system including a parallel determining unit that extracts image data of one subject from omnidirectional image data captured by the plurality of omnidirectional cameras, and determines whether orientations of the plurality of omnidirectional cameras are parallel based on whether feature amounts of the image data of the one subject coincide with each other, an orientation correcting unit that, when the parallel determining unit determines that the orientations are not parallel, makes the orientations of the plurality of omnidirectional cameras in parallel, and a distance display unit that displays, in the subject displayed as the captured image, a distance from the omnidirectional cameras to the subject.

According to the eleventh aspect of the present invention, because the omnidirectional camera captured image display system determines whether orientations of the omnidirectional cameras are parallel based on whether feature amounts of the image data of the one subject coincide with each other, makes the orientations of the plurality of omnidirectional cameras in parallel when the orientations are not parallel, and then displays, in the subject displayed as the captured image, a distance from the omnidirectional cameras to the subject, the distance from the omnidirectional cameras to the subject can be accurately measured so that the distance can be displayed together with the subject. Accordingly, the eleventh aspect of the present invention can provide a technical solution for allowing the user to know the accurate distance from the omnidirectional cameras to the subject, thereby improving the convenience of the omnidirectional camera captured image display system.

An twelfth aspect of the present invention provides an omnidirectional camera captured image display system for displaying a 3D model of a subject, which is created from a captured image obtained by capturing the subject by a plurality of omnidirectional cameras, the omnidirectional camera captured image display system including a parallel determining unit that extracts image data of one subject from omnidirectional image data captured by the plurality of omnidirectional cameras, and determines whether orientations of the plurality of omnidirectional cameras are parallel based on whether feature amounts of the image data of the one subject coincide with each other, an orientation correcting unit that, when the parallel determining unit determines that the orientations are not parallel, makes the orientations of the plurality of omnidirectional cameras in parallel, and a distance display unit that displays, in the subject displayed as the 3D model, a distance from the omnidirectional cameras to the subject.

According to the twelfth aspect of the present invention, because the omnidirectional camera captured image display system determines whether orientations of the omnidirectional cameras are parallel based on whether feature amounts of the image data of the one subject coincide with each other, makes the orientations of the plurality of omnidirectional cameras in parallel when the orientations are not parallel, and then displays, in the subject displayed as the 3D model, a distance from the omnidirectional cameras to the subject, the distance from the omnidirectional cameras to the subject can be accurately measured so that the distance can be displayed together with the subject displayed as the 3D model. Accordingly, the twelfth aspect of the present invention can provide a technical solution for allowing the user to know the accurate distance from the omnidirectional cameras to the subject displayed as the 3D model, thereby improving the convenience of the omnidirectional camera captured image display system.

According to an aspect of the present invention, it is possible to provide an omnidirectional camera captured image display system, an omnidirectional camera captured image display method, and a program for capable of facilitating knowing a distance from an omnidirectional camera to a subject or creating a 3D model corresponding to the subject displayed in an omnidirectional image, by displaying a distance from a position of the omnidirectional camera to the subject.

### BRIEF DESCRIPTION OF THE DRAWINGS

FIG. 1 is a diagram for explaining an overview of an omnidirectional camera captured image display system 1.

FIG. 2 is a diagram showing an overall configuration of an omnidirectional camera captured image display system 1.

FIG. 3 is a functional block diagram of an omnidirectional camera 100 and an information terminal 200.

FIG. 4 is a diagram showing a flowchart of a captured image display process executed by an omnidirectional camera 100 and an information terminal 200.

FIG. 5 is a flowchart showing a 3D model display process executed by an omnidirectional camera 100 and an information terminal 200.

FIG. 6 is a diagram showing an example of a measuring method of a distance executed by an information terminal 200.

FIG. 7 is a diagram showing an example of a distance displayed by an information terminal 200.

### DETAILED DESCRIPTION OF THE EMBODIMENTS

Hereinafter, embodiments for carrying out the present invention are described with reference to the drawings. It is to be understood that the embodiments are merely examples and the scope of the present invention is not limited to the disclosed embodiments.

### Overview of Omnidirectional Camera Captured Image Display System

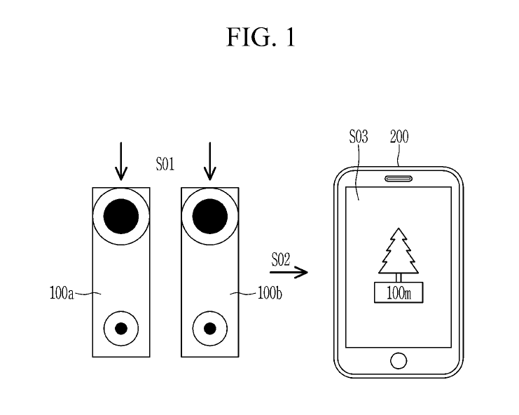

An overview of an omnidirectional camera captured image display system 1 according to an embodiment of the present invention is described with reference to FIG. 1. FIG. 1 is a diagram for explaining an overview of an omnidirectional camera captured image display system 1 according to an embodiment of the present invention. The omnidirectional camera captured image display system 1 includes omnidirectional cameras 100a and 100b (hereinafter simply referred to as an omnidirectional camera 100 unless otherwise specified) and an information terminal 200.

It is preferable to arrange the omnidirectional camera 100a and the omnidirectional camera 100b in parallel. However, if they are not arranged in parallel, the omnidirectional camera captured image display system 1 can execute a correction for arranging them in parallel. In addition, the omnidirectional camera 100a or the omnidirectional camera 100b and the information terminal 200 may not be separated from each other but may be an integrated terminal device.

Further, in the omnidirectional camera captured image display system 1, the number of omnidirectional camera(s) 100 is not limited to one or two, and may be more than two. Furthermore, the number of information terminal(s) 200 is not limited to one, and may be two or more. In addition, the information terminal 200 may be realized by either an existing device or a virtual device, or both the existing device and the virtual device. Additionally, each process described later may be realized by either the omnidirectional camera 100 or the information terminal 200, or both the omnidirectional camera 100 or the information terminal 200.

The omnidirectional camera 100 is capable of performing data communication with the information terminal 200, and is an imaging capturing device having a configuration such as a configuration of combining a plurality of cameras to from one device or a configuration of having plurality of special lenses. The omnidirectional camera 100 is an imaging capturing device that can capture images of all directions of up, down, left, and right and can capture an omnidirectional image which is a 360-degree panoramic image. The omnidirectional camera 100 may be an image capturing device that can capture images of the respective directions from a certain point and combine the captured images of the respective directions so as to capture the 360-degree panoramic image. Further, the omnidirectional camera 100 may be an image capturing device that can capture the 360-degree panoramic image by other configurations.

The information terminal 200 is capable of performing data communication with the omnidirectional camera 100 and is a terminal device that can display the 360-degree panoramic image captured by the omnidirectional camera 100. The information terminal 100 may be, for example, a mobile phone, a portable information terminal, a tablet terminal, a personal computer, an electric appliance such as a netbook terminal, a slate terminal, an electronic book terminal, or a portable music player, a wearable terminal such as a smart glasses worn by an operator or a head mount display, or other goods.

The omnidirectional camera 100 accepts an input from an operator and captures an omnidirectional image (step S01). A plurality of subjects exist in the omnidirectional image. The subject is, for example, a tree, a building, a person, or a landscape.

The omnidirectional camera 100 transmits omnidirectional image data, which are data of the captured omnidirectional image, to the information terminal 200 (step S02).

The information terminal 200 measures a distance between the omnidirectional camera 100 and the subject based on the omnidirectional image data received from the omnidirectional camera 100a, the omnidirectional image data received from the omnidirectional camera 100b and a distance between the omnidirectional camera 100a and the omnidirectional camera 100b. The information terminal 200 displays the omnidirectional image based on the omnidirectional image data and displays the measured distance on the subject displayed in the omnidirectional image (step S03).

Further, the information terminal 200 may be configured to create and display a 3D model of the subject included in the omnidirectional image data based on the omnidirectional image data. In this case, the information terminal 200 displays the 3D model of each subject based on the omnidirectional image data, and displays the measured distance in the 3D model.

The above is the overview of the omnidirectional camera captured image display system 1.

### System Configuration of Omnidirectional Camera Captured Image Display System 1

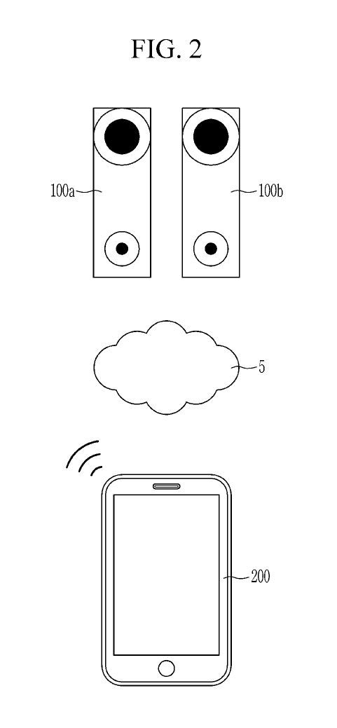

A system configuration of an omnidirectional camera captured image display system 1 is described with reference to FIG. 2. FIG. 2 is a diagram showing a system configuration of an omnidirectional camera captured image display system 1 according to an embodiment of the present invention. The omnidirectional camera captured image display system 1 includes a plurality of omnidirectional cameras 100a and 100b (hereinafter referred to as an omnidirectional camera 100 unless otherwise specified), an information terminal 200, and a public line network (the Internet network, the third or fourth generation communication networks, or the like) 5.

The number of omnidirectional cameras 100 is not limited to two, but may be one or three or more. In addition, the number of the information terminal(s) 200 is not limited to one, but may be two or more. Further, the information terminal 200 may be realized by either an existing device or a virtual device, or both the existing device and the virtual device. Additionally, each process described later may be realized by either the omnidirectional camera 100 or the information terminal 200, or both the omnidirectional camera 100 or the information terminal 200.

Further, in addition to the configuration described above, the omnidirectional camera captured image display system 1 may be configured to include a server or the like. In this case, for example, each process to be described later may be executed by any one or a combination of the omnidirectional camera 100, the information terminal 200 or the server.

The omnidirectional camera 100 has functions to be described below and is the above-described image capturing device.

The information terminal 200 has functions to be described later and is the above-described terminal device.

### Explanation of Each Function

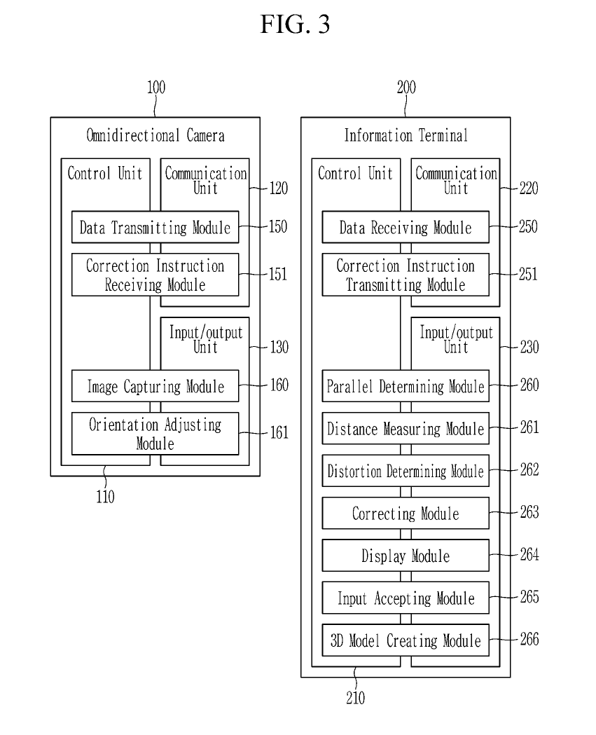

Functions of an omnidirectional camera captured image display system 1 according to an embodiment of the present invention are described with reference to FIG. 3. FIG. 3 is a functional block diagram of an omnidirectional camera 100 and an information terminal 200 according to an embodiment of the present invention.

The omnidirectional camera 100 includes, as a control unit 110, a processor such as a CPU (Central Processing Unit), a RAM (Random Access Memory), a ROM (Read Only Memory), and the like, and includes, as a communication unit, a communication device for enabling communication with another device, for example, a WiFi (Wireless Fidelity) compliant device conforming to IEEE 802.11. Further, the omnidirectional camera 100 includes, as an input/output unit 130, a display device for outputting and displaying data or images controlled by the control unit 110, an input device such as a touch panel, a keyboard, a mouse, or the like for accepting an input from a user, an image capturing device for capturing an image of the subject, or the like.

In the omnidirectional camera 100, the control unit 110 reads a predetermined program, thereby realizing a data transmitting module 150 and a correction instruction receiving module 151 in cooperation with the communication unit 120. Further, in the omnidirectional camera 100, the control unit 110 reads a predetermined program, thereby realizing an image capturing module 160 and an orientation adjusting module 161 in cooperation with the input/output unit 130.

Like the omnidirectional camera 100, the information terminal 200 includes a processor such as a CPU, a RAM, a ROM, and the like as a control unit 210, a communication device such as a wireless compliant device or the like as the communication unit 220, and a display device, an input device, or the like as an input/output unit 230.

In the information terminal 200, the control unit 210 reads a predetermined program, thereby realizing a data receiving module 250 and a correction instruction transmitting module 251 in cooperation with the communication unit 220. In addition, in the information terminal 200, the control unit 210 reads a predetermined program, thereby realizing a parallel determining module 260, a distance measuring module 261, a distortion determining module 262, a correcting module 263, a display module 264, an input accepting module 265, and a 3D model creating module 266 in cooperation with the input/output unit 230.

### Captured Image Display Process

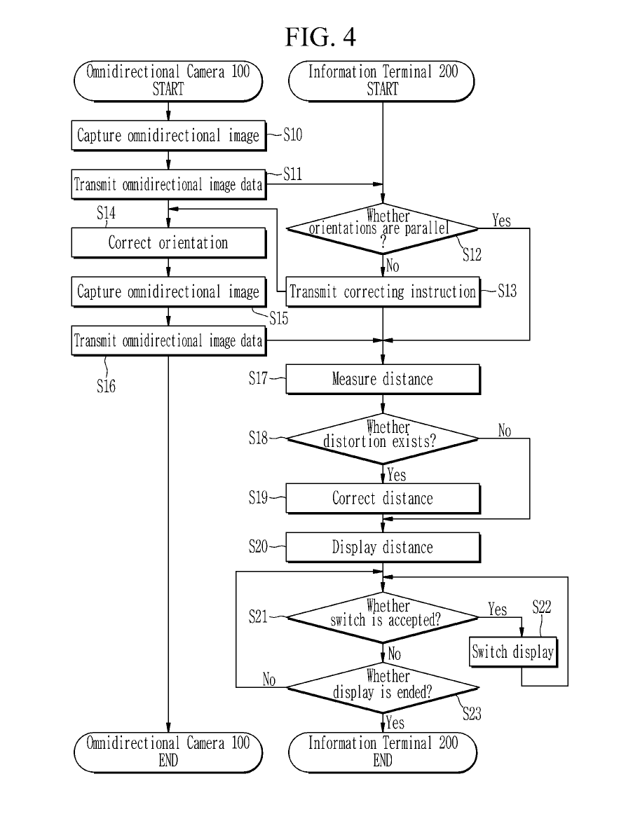

A captured image display process executed by an omnidirectional camera 100 and an information terminal 200 is described with reference to FIG. 4. FIG. 4 is a diagram showing a flowchart of a captured image display process executed by an omnidirectional camera 100 and an information terminal 200 according to an embodiment of the present invention. The processing executed by modules of each device described above is described together with this processing.

An image capturing module 160 accepts an input from an operator, captures a subject, and captures an omnidirectional image (step S10). The subject is, for example, a tree, a building, a person, or a landscape. Further, the omnidirectional image is a 360-degree panoramic image. In step S10, an omnidirectional camera 100a and an omnidirectional camera 100b captures omnidirectional images, respectively.

In step S10, the omnidirectional camera 100 may capture the omnidirectional image by the operator executing an input of an image capturing instruction on a terminal device such as a controller, may capture the omnidirectional image by accepting an input of an image capturing instruction from the information terminal 200, or may capture the omnidirectional image by other configurations.

A data transmitting module 150 transmits the captured omnidirectional image to the information terminal 200 as omnidirectional image data (step S11). In step S11, each of the omnidirectional camera 100a and the omnidirectional camera 100b transmits the omnidirectional image data.

A data receiving module 250 receives the plurality of omnidirectional image data. A parallel determining module 260 determines whether orientations of the omnidirectional cameras 100a and 100b are parallel to each other based on the plurality of received omnidirectional image data (step S12). In step S12, the parallel determining module 260 performs image analysis on the plurality of received omnidirectional image data and extracts image data of one subject. The parallel determining module 260 determines whether the omnidirectional cameras 100a and 100b are parallel based on the extracted image data of one subject. In other words, the parallel determining module 260 determines whether the omnidirectional cameras 100a and 100b are parallel based on whether feature amounts of the image data of one subject coincide with each other. When the feature amounts coincide with each other, it is determined that the omnidirectional cameras 100a and 100b are parallel. When the feature amounts do not coincide with each other, it is determined that the omnidirectional cameras 100a and 100b are not parallel. In step S12, the parallel determining module 260 may determine whether the omnidirectional cameras 100a and 100b are parallel by configurations other than the above-described determining method. In addition, even when there are three or more omnidirectional cameras 100, it is possible to determine a non-parallel omnidirectional camera 100 by executing similar processing.

In step S12, when the parallel determining module 260 determines that the omnidirectional cameras 100a and 100b are not parallel (NO in step S12), a correction instruction transmitting module 251 transmits a correcting instruction for correcting an orientation of either omnidirectional camera 100a or the omnidirectional camera 100b, or orientations of both the omnidirectional camera 100a and the omnidirectional camera 100b to a target omnidirectional camera 100 (step S13). In step S13, the correction instruction transmitting module 251 transmits the correcting instruction for instructing to, for example, change an image capturing direction of the image capturing module 160, change positions of lenses constituting the image capturing module 160, or change a position of the omnidirectional camera 100.

The correction instruction receiving module 151 receives the correction instruction. Based on the received correction instruction, an orientation adjusting module 161 corrects an orientation of the omnidirectional cameras 100a or 100b in a direction in which the omnidirectional camera 100a and the omnidirectional camera 100b becomes parallel (step S14).

The image capturing module 160 captures the omnidirectional image in the corrected orientation (step S15). In addition, in step S15, not only the corrected omnidirectional camera 100 but also the omnidirectional camera 100 that has not been corrected may capture the omnidirectional image.

The data transmitting module 150 transmits omnidirectional image data of the captured omnidirectional image to the information terminal 200 (step S16). The data receiving module 250 receives the omnidirectional image data, and the information terminal 200 executes step 17 to be described later.

On the other hand, in step S12, when the parallel determining module 260 determines that the omnidirectional cameras 100a and 100b are parallel (YES in step S12), a distance measuring module 261 measures a distance from the omnidirectional camera 100 to the subject (step S17).

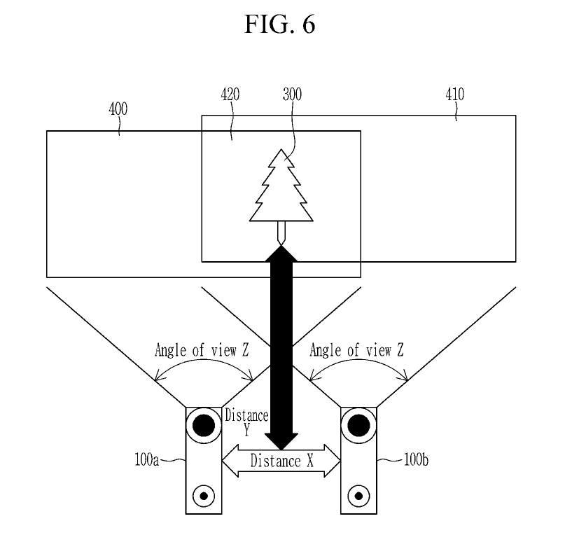

An example of a measuring method, which is executed by the omnidirectional camera captured image display system 1, for measuring the distance from the omnidirectional camera 100 to the subject is described with reference to FIG. 6. The measuring method of the distance is not limited to the method of the present embodiment, but may be executed by other methods.

The information terminal 200 measures a distance X between the omnidirectional camera 100a and the omnidirectional camera 100b. For example, the information terminal 200 acquires position information of each of the omnidirectional camera 100a and the omnidirectional camera 100b, and measures the distance X based on the acquired position information. In addition, the information terminal 200 may be configured to, when the distance X has been set in advance, acquires the set distance X. Further, the information terminal 200 may be configured to acquire the distance X from an external device such as a server. Furthermore, the information terminal 200 may be configured to measure the distance X with other configurations.

The information terminal 200 extracts the partial image 400 having an angle of view Z and including, at one end, a subject 300 whose distance is to be measured among the omnidirectional image data acquired from the omnidirectional camera 100a. In addition, the information terminal 200 extracts the partial image 410 having the angle of view Z and including, at one end, the subject 300 whose distance is to be measured among the omnidirectional image data acquired from the omnidirectional camera 100b.

The information terminal 200 creates a superimposed image 420 in which the subjects 300 included in the extracted partial images 400 and 410 are superimposed. The information terminal 200 measures a distance Y from the omnidirectional camera 100 to the subject based on the distance X and the angle of view Z of the omnidirectional camera 100. The information terminal 200 measures the distance Y with respect to all subjects existing in the omnidirectional image data. The information terminal 200 may be configured to measure the distance Y based on the distance X. Further, the information terminal 200 may be configured to measure the distance Y by other configurations.

The distortion determining module 262 determines whether distortion exists in the subject included in the omnidirectional image data (step S18). The distortion is, for example, barrel distortion, pincushion distortion, vignette, chromatic aberration or the like. In step S18, when the distortion determining module 262 determines that the distortion exists (YES in step S18), the correcting module 263 corrects the distortion of the subject, corrects the distance Y measured in step S17 based on the distortion (step

S19), and proceeds to processing in step S20 to be described later. In step S19, the correcting module 263 corrects the distance Y with respect to all subjects having distortion.

On the other hand, when the distortion determining module 262 determines that no distortion exists (NO in step S18), the display module 264 displays the omnidirectional image based on the omnidirectional image data and the distance from the omnidirectional camera 100 to the subject which is measured in step 17 (step S20). In step S20, the display module 264 displays the omnidirectional image captured by either the omnidirectional camera 100a or the omnidirectional camera 100b. In step S20, the display module 264 may be configured to synthesize the omnidirectional images captured by the omnidirectional camera 100a and the omnidirectional camera 100b and to display the synthesized omnidirectional image.

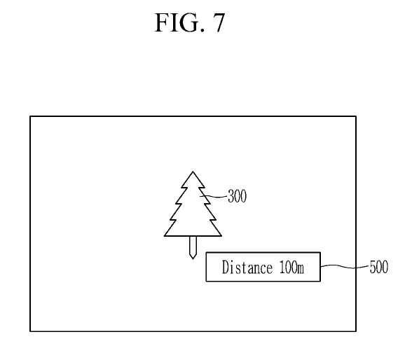

The omnidirectional image displayed by the display module 264 is described with reference to FIG. 7. FIG. 7 is a diagram showing a state in which a display module 264 displays a subject 300 and a distance display area 500 from the subject 300 to an omnidirectional camera 100. While a state in which only the subject 300 is displayed in the omnidirectional image has been shown in the present embodiment, other subjects may be displayed, and the same configuration may be applied to the other subjects in the following description.

The display module 264 displays the distance display area 500, in the vicinity of the subject 300 or by superimposing the distance display area 500 on a part of the subject 300. The vicinity is, for example, a surrounding which is not superimposed on the subject 300. The distance display area 500 is an area for displaying a distance from the omnidirectional camera 100 to the subject 300. The distance display area 500 may be configured to be displayed on an area different from a display area of the omnidirectional image. In this case, it may be configured to identify that the distance display area 500 indicates a distance to which subject, by an arrow, a tension line, a symbol, or the like. Further, a display position and a shape of the distance display area 500 may be appropriately changed. Furthermore, the distance display area 500 may be configured to display only the subject which is designated in advance, or may be configured to display all the subjects.

An input accepting module 265 determines whether an input for switching ON/OFF of the distance display is received from the operator (step S21). In step S21, when it is determined that the input is accepted (YES in step S21), the input accepting module 265 switches the distance display based on the input content (step S22). In step S22, the distance is displayed in the vicinity of the subject when the accepted input is ON, and the distance displayed in the vicinity the subject is switched to a non-display state when the accepted input is OFF. After switching the display, the input accepting module 265 executes the processing of step S21 again. In step 22, the operator may designate one subject or a plurality of subjects and switch ON/OFF of the distance of the designated subject.

On the other hand, when it is determined in step S21 that input is not accepted (NO in step S21), the input accepting module 265 determines whether an input for ending the display of the omnidirectional image is accepted (step S23). In step S23, when the input accepting module 265 determines that input is not received (NO in step S23), the input accepting module 265 executes the processing in step S21 again.

On the other hand, when it is determined in step S23 that the input is accepted (YES in step S23), the input accepting module 265 ends the present process.

The above is the captured image display process.

### 3D Model Display Process

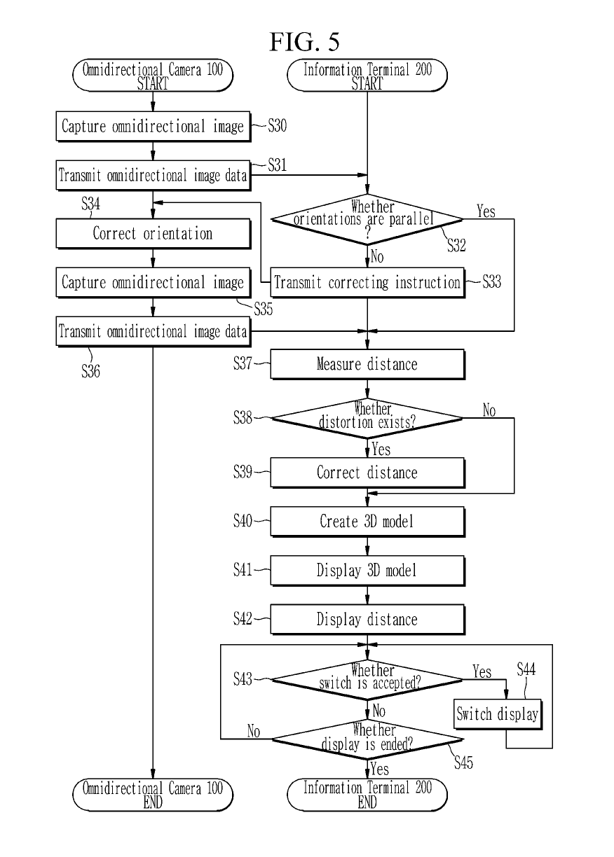

Next, a 3D model display process executed by the above-described omnidirectional camera captured image display system 1 is described with reference to FIG. 5. FIG. 5 is a flowchart showing a 3D model display process executed by an omnidirectional camera 100 and an information terminal 200. The processing executed by modules of each device described above is described together with this processing. A detailed description of the same processing as the captured image display process described above is omitted.

An omnidirectional camera 100 and an information terminal 200 execute the processings from step S10 to step S19 (steps S30 to S39). Since the processings of steps S30 to S39 are similar to the processings of steps S10 to S19 described above, detailed descriptions thereof are omitted.

A 3D model creating module 266 creates a 3D model of each subject based on omnidirectional image data (step S40). The 3D model creating module 266 creates the 3D model with, for example, a solid, a surface, a wire frame, or a polygon. In step S40, the 3D model creating module 266 creates the 3D model of each subject based on the omnidirectional image data captured by either an omnidirectional camera 100a or an omnidirectional camera 100b. In step S40, the 3D model creating module 266 may synthesize the omnidirectional image data captured by the omnidirectional camera 100a and the omnidirectional camera 100b and creates the 3D model based on the synthesized omnidirectional image data.

A display module 264 displays the created 3D model of the subject instead of the subject in the omnidirectional image (step S41). That is, in step S41, the display module 264 displays the 3D model of each subject as the omnidirectional image.

The display module 264 displays a distance from the omnidirectional camera 100 to the subject measured in step S37 in the 3D model (step S42). The processing in step S42 is the same as the above-described processing in step S20 except that the image of the subject to be displayed is changed to the 3D model. Therefore, the detailed description thereof is omitted.

An input accepting module 265 determines whether an input for switching ON/OFF of a distance display is received from an operator (step S43). In step S43, when it is determined that the input is received (YES in step S43), the input accepting module 265 switches the distance display based on the input content (step S44). The processings in step S43 and step S44 are the same as the processings in step S21 and step S22 described above except that the image of the subject to be displayed is changed to the 3D model. Therefore, the detailed description thereof is omitted.

On the other hand, when it is determined in step S43 that the input is not received (NO in step S43), the input accepting module 265 determines whether an input for ending the display of the 3D model is received (step S45). In step S45, when the input accepting module 265 determines that input is not received (NO in step S45), the input accepting module 265 executes the processing in step S42. Since the processing of step S45 is the same as the processing of step S23 described above, a detailed description thereof is omitted.

On the other hand, when it is determined in step S45 that the input is received (YES in step S45), the input accepting module 265 ends the present process.

The above is the 3D model display process.

According to an embodiment, when the orientations of the plurality of omnidirectional cameras are not in parallel, a distance from the omnidirectional cameras to the subject is measured. Accordingly, the distance from the omnidirectional cameras to the subject can be accurately measured so that the distance can be displayed together with the subject.

The means and functions described above are realized by reading and executing a predetermined program by a computer (including a CPU, an information processing device, or various terminals). The program is provided, for example, in a form recorded in a computer-readable recording medium such as a flexible disk, a CD (e.g., CD-ROM or the like), a DVD (DVD-ROM, DVD-RAM, or the like), or the like. In this case, the computer reads the program from the recording medium and transfers the program to an internal storage unit or an external storage unit so as to be stored and executed. Furthermore, the program may be, for example, recorded in a storage device (recording medium) such as a magnetic disk, an optical disk, an optical magnetic disk, or the like in advance and be provided from the recording medium to the computer through a communication line.

While the embodiments of the present invention have been described above, the present invention is not limited to the above-described embodiments. In addition, the effects described in the embodiments of the present invention are merely a list of the most preferable effects produced by the present invention, and the effects of the present invention are limited to those described in the embodiments of the present invention.

### Description Of Reference Numbers

1: omnidirectional camera captured image display system, 100: omnidirectional camera, 200: information terminal

What is claimed is:

1. An omnidirectional camera captured image display system for displaying a captured image obtained by capturing a subject by a plurality of omnidirectional cameras, the omnidirectional camera captured image display system comprising:
a parallel determining unit that extracts image data of one subject from omnidirectional image data captured by the plurality of omnidirectional cameras, and determines whether orientations of the plurality of omnidirectional cameras are parallel based on whether feature amounts of the image data of the one subject coincide with each other;
an orientation correcting unit that, when the parallel determining unit determines that the orientations are not parallel, makes the orientations of the plurality of omnidirectional cameras in parallel; and
a distance display unit that displays, in the subject displayed as the captured image, a distance from the omnidirectional cameras to the subject.

2. The omnidirectional camera captured image display system according to claim 1, further comprising:
a receiving unit that receives a user operation; and
a switching unit that switches ON/OFF of display of the distance by receiving the user operation.

3. The omnidirectional camera captured image display system according to claim 1, further comprising a distance correcting unit that corrects the distance from distortion of the captured image.

4. The omnidirectional camera captured image display system according to claim 1, further comprising a measuring unit that measures a distance between the plurality of omnidirectional cameras.

5. An omnidirectional camera captured image display system for displaying a 3D model of a subject, which is created from a captured image obtained by capturing the subject by a plurality of omnidirectional cameras, the omnidirectional camera captured image display system comprising:
a parallel determining unit that extracts image data of one subject from omnidirectional image data captured by the plurality of omnidirectional cameras, and determines whether orientations of the plurality of omnidirectional cameras are parallel based on whether feature amounts of the image data of the one subject coincide with each other;
an orientation correcting unit that, when the parallel determining unit determines that the orientations are not parallel, makes the orientations of the plurality of omnidirectional cameras in parallel; and
a distance display unit that displays, in the subject displayed as the 3D model, a distance from the omnidirectional cameras to the subject.

6. The omnidirectional camera captured image display system according to claim 5, further comprising:
a receiving unit that receives a user operation; and
a switching unit that switches ON/OFF of display of the distance by receiving the user operation.

7. The omnidirectional camera captured image display system according to claim 5, further comprising a distance correcting unit that corrects the distance from distortion of the captured image.

8. The omnidirectional camera captured image display system according to claim 5, further comprising a measuring unit that measures a distance between the plurality of omnidirectional cameras.

9. An omnidirectional camera captured image display method for displaying a captured image obtained by capturing a subject by a plurality of omnidirectional cameras, the omnidirectional camera captured image display method comprising:
extracting image data of one subject from omnidirectional image data captured by the plurality of omnidirectional cameras, and determining whether orientations of the plurality of omnidirectional cameras are parallel based on whether feature amounts of the image data of the one subject coincide with each other;
when determining that the orientations of the plurality of omnidirectional cameras are not parallel, making the orientations of the plurality of omnidirectional cameras in parallel; and
displaying, in the subject displayed as the captured image, a distance from the omnidirectional cameras to the subject.

10. An omnidirectional camera captured image display method for displaying a 3D model of a subject, which is created from a captured image obtained by capturing the subject by a plurality of omnidirectional cameras, the omnidirectional camera captured image display method comprising:
extracting image data of one subject from omnidirectional image data captured by the plurality of omnidirectional cameras, and determining whether orientations of the plurality of omnidirectional cameras are parallel based on whether feature amounts of the image data of the one subject coincide with each other;
when determining that the orientations of the plurality of omnidirectional cameras are not parallel, making the orientations of the plurality of omnidirectional cameras in parallel; and
displaying, in the subject displayed as the 3D model, a distance from the omnidirectional cameras to the subject.

11. A program for causing an omnidirectional camera captured image display system for displaying a captured image obtained by capturing a subject by a plurality of omnidirectional cameras to execute:
extracting image data of one subject from omnidirectional image data captured by the plurality of omnidirectional cameras, and determining whether orientations of the plurality of omnidirectional cameras are parallel based on whether feature amounts of the image data of the one subject coincide with each other;
when determining that the orientations of the plurality of omnidirectional cameras are not parallel, making the orientations of the plurality of omnidirectional cameras in parallel; and
displaying, in the subject displayed as the captured image, a distance from the omnidirectional cameras to the subject.

12. A program for causing an omnidirectional camera captured image display system for displaying a 3D model of a subject, which is created from a captured image obtained by capturing the subject by a plurality of omnidirectional cameras, to execute:
extracting image data of one subject from omnidirectional image data captured by the plurality of omnidirectional cameras, and determining whether orientations of the plurality of omnidirectional cameras are parallel based on whether feature amounts of the image data of the one subject coincide with each other;
when determining that the orientations of the plurality of omnidirectional cameras are not parallel, making the orientations of the plurality of omnidirectional cameras in parallel; and
displaying, in the subject displayed as the 3D model, a distance from the omnidirectional cameras to the subject.
